(19) United States
(12) Patent Application Publication
(10) Pub. No.: US 2024/0107463 A1
(43) Pub. Date: Mar. 28, 2024

(54) SETTING POWER CONTROL CONFIGURATION PARAMETERS IN A COMMUNICATIONS NETWORK WITH DECOUPLED DL AND UL TRANSMISSION

(71) Applicant: Telefonaktiebolaget LM Ericsson (publ), Stockholm (SE)

(72) Inventors: Niklas WERNERSSON, Kungsängen (SE); Anders FURUSKÄR, Stockholm (SE)

(21) Appl. No.: 18/274,639

(22) PCT Filed: Mar. 1, 2021
(86) PCT No.: PCT/SE2021/050168

§ 371 Date: Jul. 27, 2023

(51) Int. Cl. H04W 52/24; H04W 52/14; H04W 72/044; H04W 72/40

(52) U.S. Cl. CPC H04W 52/245; H04W 52/146; H04W 72/0473; H04W 72/40

(57) ABSTRACT

A computer implemented method performed by a first node in a communications network for setting a power control configuration parameter with which a user equipment, UE, should send further transmissions to a second node in the communications network. The method includes: obtaining the power control configuration parameter with which the UE should send the further transmissions to be received by the second node, the power control configuration parameter being based on an estimated received power of an initial transmission sent from the UE and received by the second node, as measured at the second node. the method further includes sending a second message to the UE indicating the obtained power control configuration parameter.

### TECHNICAL FIELD

This disclosure relates to methods, nodes and systems in a communications network. More particularly but non-exclusively, the disclosure relates to setting power control configuration parameters for User Equipments, UEs, in communications networks.

### BACKGROUND

This disclosure relates to communications networks (e.g. telecommunications networks). Setting output power levels of transmitters and base stations in downlink, and mobile stations in uplink is commonly referred to as power control (PC). Objectives of PC include improved capacity, coverage, improved system robustness, and reduced power consumption.

In New Radio (NR) uplink (UL) PC mechanisms can be categorized into (i) open-loop, (ii) closed-loop, and (iii) combined open- and closed loop. These differ in what input is used to determine the transmit power. In the open-loop case, the transmitter measures a signal sent from the receiver, and sets its output power based on this. In the closed-loop case, the receiver measures the signal from the transmitter, and based on this sends a Transmit Power Control (TPC) command to the transmitter, which then sets its transmit power accordingly. In a combined open- and closed-loop scheme, both inputs are used to set the transmit power.

In principle, UL power control tries to enable the behavior as illustrated in FIG. 1. A base station 102 receiving transmissions from different User Equipments (UEs) 104 aims to receive said transmissions with a certain target received power level, as indicated in the figure by the dash-dot line 106. The target received power level is set so as to receive transmissions with sufficient power whilst minimising unnecessary energy expenditure at the UEs. The target received power level can be obtained by letting the UE's transmit power vary with the estimated path loss in the DL. As can be seen in FIG. 1, the UL transmit power 110 is varied with the distance to the base station according to the known pathloss profile 108 in such a way that the received power at the base station 102 equals the target received power 106. The transmit power at the UE necessary to achieve the target received power is indicated by the dashed line 110. The pathloss profile of the base station 102 in downlink is shown by the line 112.

### UL PC in NR Release 15

For the purpose of explanation, the following discussion will focus on UL PC as in NR. Other power control systems are similar, however, and it will be appreciated that the principles described herein can be applied equally to power control in other communications networks such as, for example, Long Term Evolution networks, LTE.

In NR release 15 (as described in TR 38.213 v15.11.0) the UE initially performs PC for Physical Random Access Channel (PRACH) using:

P_{PRACH,b,f,c}(i)min{P_{CMAX,f,c}(i),P_{PRACH,target,f,c}+PL_{b,f,c}} [dBm],

After a connection is established between the UE and the eNodeB the UE can be configured for performing UL PC also on Physical Uplink Control Channel (PUCCH), Physical Uplink Shared Channel (PUSCH) and Sounding Reference Signal (SRS) transmission. Setting the UE transmit power for a PUCCH transmission is performed using:

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix}\end{matrix} \} [ dBm ]$$

Here P_{PUCCH,b,f,c}(i, qᵤ, q_{d}, l) is the transmit power to use for PUCCH and PL_{b,f,c} (q_{d}) is the pathloss estimated by the UE. For PUSCH one instead uses the equation:

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ]$$

where c denotes the serving cell and P_{PUSCH,b,f,c} (i, j, q_{d}, l) is the transmit power to use in a given transmission occasion i.

For SRS one defines:

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} [ dBm ]$$

In the above formulas PL_{b,f,c}(q_{d}) and PL_{b,f,c} (qₛ) are used for open loop power control whereas the three terms g_{b,f,c}(i,l), f_{b,f,c}(i,l) and h_{b,f,c}(i,l) are used for closed loop power control.

Although the formulas for PUCCH, PUSCH and SRS are different, they are at a high level, from the perspective of closed loop and open loop power control, quite similar. Therefore, although the following discussion focuses on PUSCH UL PC, the disclosures herein can equally be applied to PUCCH and SRS PC as well.

### PUSCH Open Loop Power Control

The open loop PC is based on PL_{b,f,c}(q_{d}) which is a downlink pathloss estimate in dB calculated by the UE measuring on a reference signal (RS) represented by index q_{d}. This is shown in FIG. 2 whereby a node 202 transmits a RS 206 to a UE 204. A TPC and the reference signal represented by index q_{d} are transmitted in DL and PUSCH is transmitted in UL 208 with the power P_{PUSCH,b,f,c}(i, j, q_{d}, l).

Hence, by measuring on this RS the UE is able to compensate for the pathloss by adjusting its transmission power. Furthermore, by controlling the configurable parameter α_{b,f,c}(j) it is also possible to control to the extent to which the UE should adjust its transmission power based on the open loop power control (α_{b,f,c} (j)=0 means no adjustment and α_{b,f,c}(j)=1 means “full adjustment”).

### PUSCH Closed Loop Power Control

The term f_{b,f,c}(i,l) can be configured to one of two modes:

$${f}_{b , f , c} ( i , l ) = {δ}_{PUSCH , b , f , c} ( i , l ) or \\ {f}_{b , f , c} ( i , l ) = {f}_{b , f , c} ( i - {i}_{0} , l ) + {\sum }_{m = 0}^{𝒞 ( {D}_{i} ) - 1} {δ}_{PUSCH , b , f , c} ( m , l )$$

where the later configuration is referred to as the “TPC accumulation mode”. Furthermore, the value δ_{PUSCH,b,f,c}(i,l) is the TPC (Transmission Power Control) command value included in a DCI of format 0_0, format 0_1 or format 2_2. The possible values of δ_{PUSCH,b,f,c}(i,l) are given in the Table in Annex 1. Hence, using TPC, a node such as a gNB is able to impact UE output power.

### Beam Specific PUSCH Power Control

NR supports “beam specific” UL PC by e.g. letting P_{O_PUSCH,b,f,c}(j) be a function of the index j where j∈{0, 1, . . . , J−1}. Hence, in this sense different “beams” (represented by different values of j) may be configured with different values of P_{O_PUSCH,b,f,c}. Which j to use when deriving P_{PUSCH,b,f,c}(i, j, q_{d}, l) for a given PUSCH transmission may in turn be signaled via a DCI message or via MAC CE. (The same holds for α_{b,f,c} (j)).
Furthermore, PL_{b,f,c} (q_{d}) may also be beam specific in the sense that q_{d} may be signaled to the UE with the implication that a different RS is used to perform the open loop power control.
As yet another component of the “beam specific” UL PC we point out that there may be multiple sets of also f_{b,f,c}(i,l) which are then controlled by the index I which can be signaled in the DL.

### Power Headroom Reporting

There are different kinds of power headroom reports (PHRs) in NR assuming e.g. PUSCH-only transmission or assuming combined PUSCH and PUCCH transmission etc. As an example type 1 PH R is given as:

PH_{type1,b,f,c}(i,j,q_{d},l)=P_{CMAX,f,c}(i)−{P_{O_PUSCH,b,f,c}(j)+10 log₁₀(2^{μ}·M_{RB,b,f,c}^{PUSCH}(i))+α_{b,f,c}(j)·PL_{b,f,c}(q_{d})+Δ_{TF,b,f,c}(i)+f_{b,f,c}(i,l)}

### SUMMARY

It is expected that the number of UEs in communications networks and the data requirements of each such UE will increase over time. As such, communications networks are facing ever increasing demands on capacity. It is also expected that UL will become a limiting factor, partly due to the natural imbalance of spectral efficiency between UL and downlink (DL), which arises for instance from the differing numbers of antennas, and relatively lower power capabilities of UEs compared to downlink antennae etc., but also partly due to an increase of UL heavy services like gaming, and V2V communication etc.

A potential remedy to this is to densify networks more in the UL than in the DL. This may be done by for instance, by providing radio nodes that only receive in the UL (they do hence not perform any DL transmissions). Such a transmission node may be described as an “UL only node” herein. By using such UL only radio nodes, UL capabilities may be enhanced without enhancing the DL, hence addressing the UL/DL imbalance. This approach, however, makes the process of UL power control challenging since, as described above, the NR/LTE UL power control frameworks have been designed around the idea that one uses a DL transmission from the serving node to decide the power of the UL transmission to the same serving node.

This problem is illustrated in FIG. 3 whereby the “UL only radio node” 304 acts as an intermediary node and forwards UL traffic from UEs 306, 308 to base station 302. If power control is set based on reference signals from base station 302, then the received power at the UL only node 304 is above the target received power 310, wasting power resources of the UEs 306, 308 and generating interference that can have a negative impact on system performance.

It is an object of embodiments herein to address these issues and others.

Thus, according to a first aspect there is a computer implemented method performed by a first node in a communications network for setting a power control configuration parameter with which a user equipment, UE, should send further transmissions to a second node in the communications network. The method comprises: obtaining the power control configuration parameter with which the UE should send the further transmissions to be received by the second node, the power control configuration parameter being based on an estimated received power of an initial transmission sent from the UE and received by the second node, as measured at the second node; and sending a second message to the UE indicating the obtained power control configuration parameter.

In some embodiments, the second node may be an uplink only node. For example, the second node may act as an intermediary node and forward transmissions from the UE to the first node.

According to a second aspect there is a computer implemented method performed by a second node in a communications network for setting a power control configuration parameter with which a user equipment, UE, should send further transmissions that are to be received by the second node. The method comprises: determining an estimated received power of an initial transmission sent by the UE and received by the second node; and sending a first message to a first node, to cause the first node to send a second message to the UE indicating a power control configuration parameter with which the UE should send the further transmissions, wherein the power control configuration parameter is determined based on the estimated received power.

According to a third aspect there is a computer implemented method in a user equipment, UE, in a communications network for setting a power control configuration parameter with which the UE should send further transmissions to be received by a second node in the communications network. The method comprises: sending an initial transmission to be received by the second node, to enable the second node to estimate the received power of the initial transmission; and receiving a second message from a first node, indicating a determined power control configuration parameter with which the UE should send further transmissions to be received by the second node, based on the estimated received power of the initial transmission.

According to a fourth aspect there is a first node in a communications network for setting a power control configuration parameter with which a user equipment, UE, should send further transmissions to a second node in the communications network. The first node comprises a memory comprising instruction data representing a set of instructions; and a processor configured to communicate with the memory and to execute the set of instructions. The set of instructions, when executed by the processor, cause the processor to obtain the power control configuration parameter with which the UE should send the further transmissions to be received by the second node, the power control configuration parameter being based on an estimated received power of an initial transmission sent from the UE and received by the second node, as measured at the second node, and send a second message to the UE indicating the obtained power control configuration parameter.

According to a fifth aspect there is a first node in a communications network for setting a power control configuration parameter with which a user equipment, UE, should send further transmissions to a second node in the communications network. The first node is configured to obtain the power control configuration parameter with which the UE should send the further transmissions to be received by the second node, the power control configuration parameter being based on an estimated received power of an initial transmission sent from the UE and received by the second node, as measured at the second node, and send a second message to the UE indicating the obtained power control configuration parameter.

According to a sixth aspect there is a second node in a communications network for setting a power control configuration parameter with which a user equipment, UE, should send further transmissions that are to be received by the second node. The second node comprises a memory comprising instruction data representing a set of instructions; and a processor configured to communicate with the memory and to execute the set of instructions. The set of instructions, when executed by the processor, cause the processor to: determine an estimated received power of an initial transmission sent by the UE and received by the second node; and send a first message to a first node, to cause the first node to send a second message to the UE indicating a power control configuration parameter with which the UE should send the further transmissions, wherein the power control configuration parameter is determined based on the estimated received power.

According to a seventh aspect there is a second node in a communications network for setting a power control configuration parameter with which a user equipment, UE, should send further transmissions that are to be received by the second node. The second node is configured to: determine an estimated received power of an initial transmission sent by the UE and received by the second node; and send a first message to a first node, to cause the first node to send a second message to the UE indicating a power control configuration parameter with which the UE should send the further transmissions, wherein the power control configuration parameter is determined based on the estimated received power.

According to an eighth aspect there is a user equipment, UE, in a communications network, for setting a power control configuration parameter with which the UE should send further transmissions to be received by a second node in the communications network. The UE is configured to: send an initial transmission to be received by the second node, to enable the second node to estimate the received power of the initial transmission; and receive a second message from a first node, indicating a determined power control configuration parameter with which the UE should send further transmissions to be received by the second node, based on the estimated received power of the initial transmission.

According to a ninth aspect there is a computer program comprising instructions which, when executed on at least one processor, cause the at least one processor to carry out a method according to any of the first, second or third aspects.

According to a tenth aspect there is a carrier containing a computer program according to the ninth aspect, wherein the carrier comprises one of an electronic signal, optical signal, radio signal or computer readable storage medium.

According to an eleventh aspect there is a computer program product comprising non transitory computer readable media having stored thereon a computer program according to the ninth aspect.

Embodiments herein thus enable power control to be performed for transmissions from a UE to a second node without the second node being required to transmit (e.g. send a reference signal) to the UE. Ordinarily, as described above, if a UE were to transmit to a second node, the power control parameters for the transmissions would be determined in an open- or closed-loop manner based on initial transmissions between the UE and the respective second node. However, in situations, for example, where the second node is only configured to receive uplink transmissions, embodiments herein propose that power configuration parameters for the UE are set based on an estimated receive power of an initial transmission sent from the UE to the second node. The determined power configuration parameters are then sent to the UE via a first node. In this way, power control may be performed in an efficient and effective manner in scenarios where there is decoupled DL and UL transmission.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows a prior art power control process between a UE and a first node;

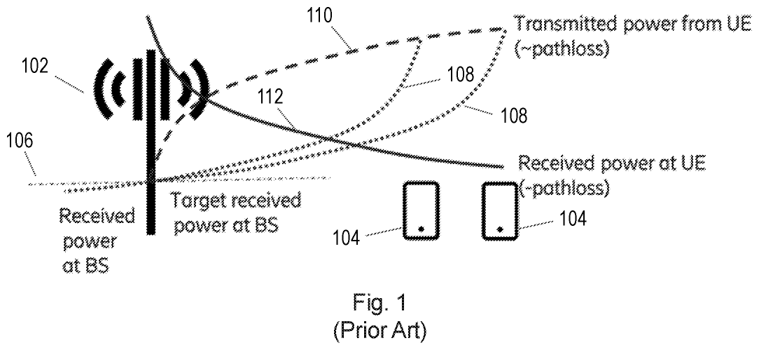

FIG. 2 shows a prior art power control process between a UE and a first node;

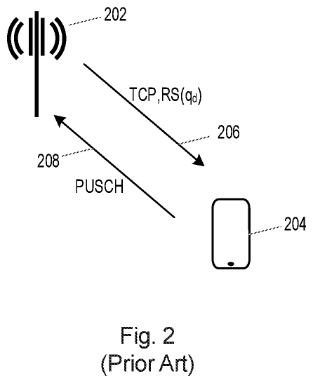

FIG. 3 illustrates a limitation of prior art power control processes when an uplink only node is employed in a communications network;

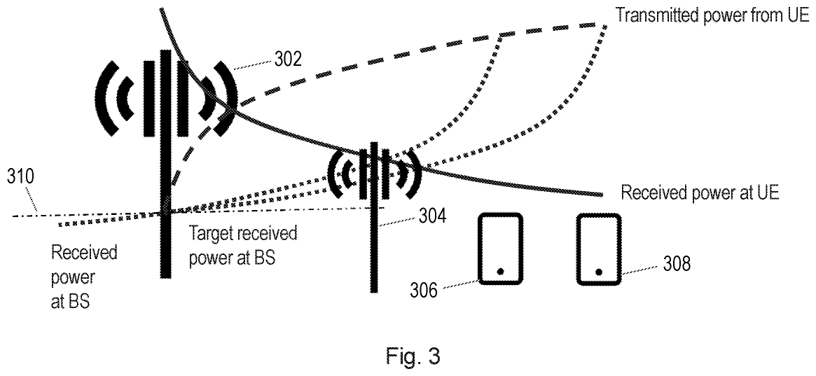

FIG. 4 shows a power control process according to some embodiments herein;

FIG. 5 shows a node according to some embodiments herein;

FIG. 6 shows a UE according to some embodiments herein;

FIG. 7 shows a method in a first node according to some embodiments herein;

FIG. 8 shows a method according to some embodiments herein;

FIG. 9 illustrates a method according to some embodiments herein;

FIG. 10 shows a method in a second node according to some embodiments herein; and

FIG. 11 shows a method in a user equipment, UE, according to some embodiments herein.

### DETAILED DESCRIPTION

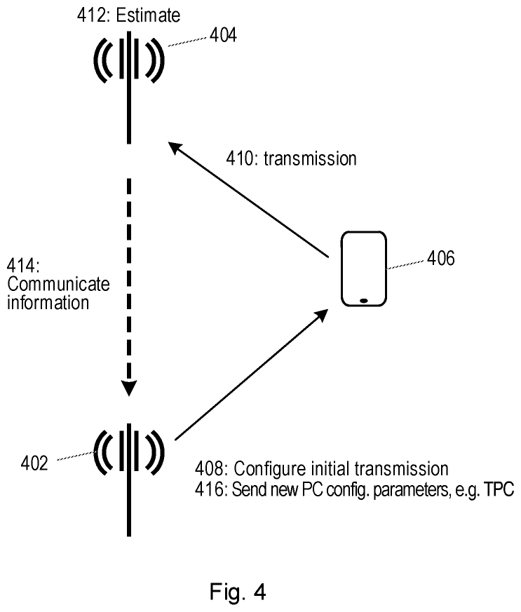

As illustrated in FIG. 4, the disclosure herein relates generally to power control (PC) processes for transmissions from a UE 406 to a second node 404. In FIG. 4 the second node 404 is an uplink (UL) only node and thus the second node 404 is not able to transmit to the UE in the downlink (DL). Ordinarily, power control configuration parameters for the UE would be set through open-, closed-, or combined open- and closed-power control processes involving transmissions sent between the UE and second node 404 however these processes are not possible in this scenario.

What is proposed herein are new power control methods to overcome these problems. As an example, in some embodiments, a first node 402 (which may be a scheduling base station) configures 408 an initial UL transmission from a UE 406 using first power control parameters. Said UE performs 410 the initial transmission and the second node 404 (which is UL-only) receives said initial transmission and estimates 412 the received power of the initial transmission. The second node 404 communicates 414 information related to the estimated received power to the first node 402. The second node determines new power control parameters for the UE 406 based on the information related to estimated received power, and configures 416 further UL transmissions from said UE to the second node, using the new power control configuration parameters.

Thus, the power control processes described herein enable UL power control when DL transmission (or rather DCI) is performed from another radio node than the one receiving the UL transmission. This embodiment and others are described in more detail below.

More generally, the disclosure herein relates to a communications network (or telecommunications network). A communications network may comprise any one, or any combination of: a wired link (e.g. ASDL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

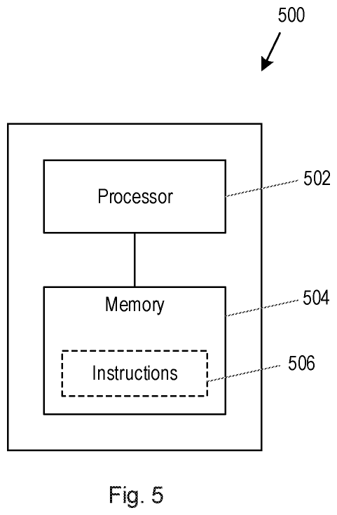

Embodiments herein relate to nodes (e.g. network nodes) in a communications network as described above. FIG. 5 illustrates an example network node 500 in a communications network according to some embodiments herein. Generally, the node 500 may comprise any component or network function (e.g. any hardware or software module) in the communications network suitable for performing the functions described herein. For example, a node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC).

A node such as the node 500 may be configured (e.g. adapted, operative, or programmed) to perform any of the embodiments of the methods described below, such as the methods 700 or 1000 described below. It will be appreciated that the node 500 may comprise one or more virtual machines running different software and/or processes. The node 500 may therefore comprise one or more servers, switches and/or storage devices and/or may comprise cloud computing infrastructure or infrastructure configured to perform in a distributed manner, that runs the software and/or processes.

Generally, a node 500 may comprise a processor (e.g. processing circuitry or logic) 502. The processor 502 may control the operation of the node 500 in the manner described herein. The processor 502 can comprise one or more processors, processing units, multi-core processors or modules that are configured or programmed to control the node 500 in the manner described herein. In particular implementations, the processor 502 can comprise a plurality of software and/or hardware modules that are each configured to perform, or are for performing, individual or multiple steps of the functionality of the node 500 as described herein.

The node 500 may comprise a memory 504. In some embodiments, the memory 504 of the node 500 can be configured to store program code or instructions 506 that can be executed by the processor 502 of the node 500 to perform the functionality described herein. Alternatively or in addition, the memory 504 of the node 500, can be configured to store any requests, resources, information, data, signals, or similar that are described herein. The processor 502 of the node 500 may be configured to control the memory 504 of the node 500 to store any requests, resources, information, data, signals, or similar that are described herein.

It will be appreciated that a node 500 may comprise other components in addition or alternatively to those indicated in FIG. 5. For example, in some embodiments, the node 500 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 502 of node 500 may be configured to control such a communications interface to transmit to and/or receive from other nodes or network functions requests, resources, information, data, signals, or similar.

Some embodiments herein relate to User Equipments, UEs. A UE may comprise a device capable, configured, arranged and/or operable to communicate wirelessly with network nodes and/or other wireless devices. Unless otherwise noted, the term UE may be used interchangeably herein with wireless device (WD). Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A UE as described above may represent the endpoint of a wireless connection, in which case the device may be referred to as a wireless terminal. Furthermore, a UE as described above may be mobile, in which case it may also be referred to as a mobile device or a mobile terminal.

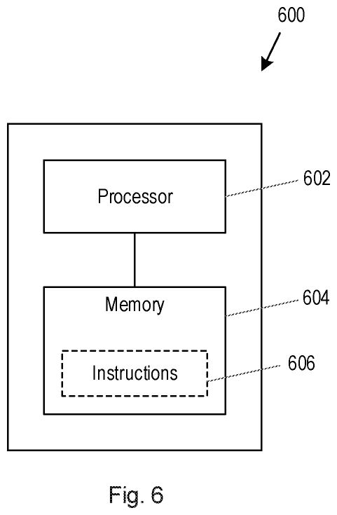

FIG. 6 illustrates a UE 600. UE 600 may be configured or operative to perform the methods and functions described herein, such as the method 1100 as described below. The UE 600 may comprise a processor (or logic) 602. It will be appreciated that the UE 600 may comprise one or more virtual machines running different software and/or processes. The UE 600 may therefore comprise one or more servers, switches and/or storage devices and/or may comprise cloud computing infrastructure or infrastructure configured to perform in a distributed manner, that runs the software and/or processes.

The processor 602 may control the operation of the UE 600 in the manner described herein. The processor 602 can comprise one or more processors, processing units, multi-core processors or modules that are configured or programmed to control the UE 600 in the manner described herein. In particular implementations, the processor 602 can comprise a plurality of software and/or hardware modules that are each configured to perform, or are for performing, individual or multiple steps of the functionality of the UE 600 as described herein.

The UE 600 may comprise a memory 604. In some embodiments, the memory 604 of the UE 600 can be configured to store program code or instructions that can be executed by the processor 602 of the UE 600 to perform the functionality described herein. Alternatively or in addition, the memory 604 of the UE 600, can be configured to store any requests, resources, information, data, signals, or similar that are described herein. The processor 602 of the UE 600 may be configured to control the memory 604 of the UE 600 to store any requests, resources, information, data, signals, or similar that are described herein.

It will be appreciated that the UE 600 may comprise other components in addition or alternatively to those indicated in FIG. 6. For example, the UE 600 may comprise a communications interface. The communications interface may be for use in communicating with other UEs and/or nodes in the communications network, (e.g. such as other physical or virtual nodes such as the node 600 described above). For example, the communications interface may be configured to transmit to and/or receive from nodes or network functions requests, resources, information, data, signals, or similar. The processor 602 of UE 600 may be configured to control such a communications interface to transmit to and/or receive from nodes or network functions requests, resources, information, data, signals, or similar.

Generally, the disclosure herein relates to a first node 402, a second node 404 and a UE 406, 600 in a communications system.

The first node 402 may be a scheduling base station. The first node 402 may generally be configured to perform both uplink and downlink transmissions to other nodes and/or UEs in the communications network. The first node 402 may be configured to perform the method 700 as described below. Nodes were described above with respect to FIG. 5 and the detail therein will be understood to apply equally to the first node 402. For example, the first node 402 may be any of the types of nodes listed above with respect to FIG. 5 and be configured in any of the manners listed therein.

Generally, the first node 402 is for setting a power control configuration parameter with which a user equipment, UE, should send further transmissions to a second node in the communications network. The first node is configured (e.g. adapted) to: obtain the power control configuration parameter with which the UE should send the further transmissions to be received by the second node, the power control configuration parameter being based on an estimated received power of an initial transmission sent from the UE and received by the second node, as measured at the second node; and send a second message to the UE indicating the obtained power control configuration parameter.

In some embodiments, the second node 404 may be an uplink only node. For example, in some embodiments, the second node is configured to receive uplink transmissions from the UE but is not configured to transmit in the downlink to the UE. For example, the second node may act as an intermediary node and forward transmissions from the UE to the first node (or other nodes) in the communications system. The second node 404 may be configured to perform the method 1000 as described below. Nodes were described above with respect to FIG. 5 and the detail therein will be understood to apply equally to the second node 404. For example, the second node 404 may be any of the types of nodes listed above with respect to FIG. 5 and be configured in any of the manners listed therein.

Briefly, the second node 404 is for setting a power control configuration parameter with which a user equipment, UE, should send further transmissions that are to be received by the second node. The second node is configured to: determine an estimated received power of an initial transmission sent by the UE and received by the second node; and send a first message to a first node, to cause the first node to send a second message to the UE indicating a power control configuration parameter with which the UE should send the further transmissions, wherein the power control configuration parameter is determined based on the estimated received power.

In some embodiments herein, the UE 406, 600 transmits to the second node 404 (which may be uplink only) in the UL and receives DL transmissions from the first node 402. It is noted that the first node and the second node may be located at different geographical locations.

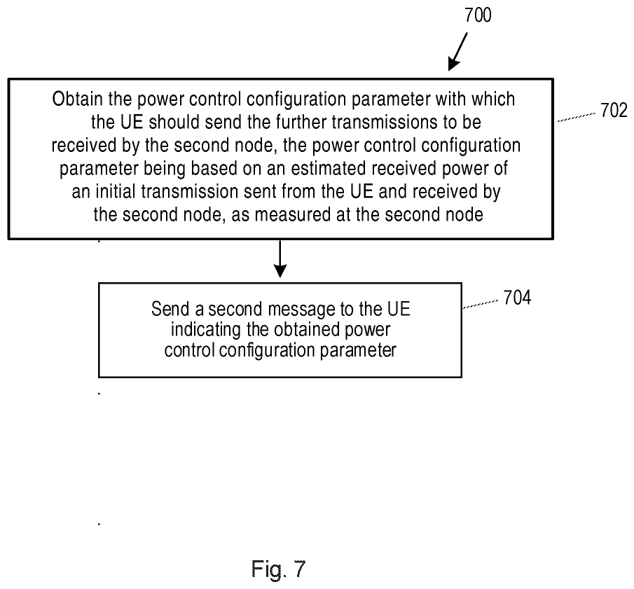

FIG. 7 illustrates a computer implemented method 700 that may be performed by the first node 402 according to some embodiments herein. The method 700 is for setting a power control configuration parameter with which a user equipment, UE, should send further transmissions to a second node in the communications network. Briefly, in a first step, the method 700 comprises obtaining 702 the power control configuration parameter with which the UE should send the further transmissions to be received by the second node, the power control configuration parameter being based on an estimated received power of an initial transmission sent from the UE and received by the second node, as measured at the second node. In a second step the method then comprises sending 704 a second message to the UE indicating the obtained power control configuration parameter.

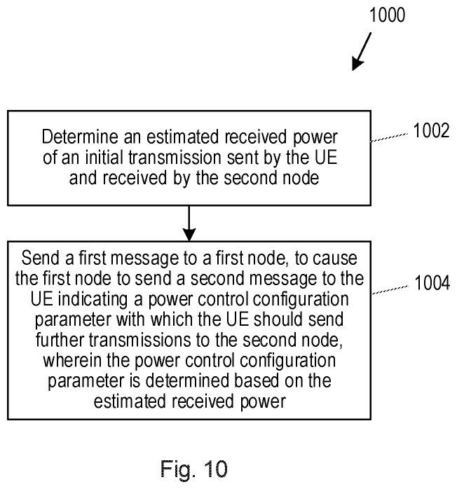

FIG. 10 illustrates a computer implemented method 1000 that may be performed by the second node 404 according to some embodiments herein. The method 1000 is for setting a power control configuration parameter with which a user equipment, UE, should send further transmissions that are to be received by the second node. Briefly, the method 1000 comprises in a first step, determining 1002 an estimated received power of an initial transmission sent by the UE and received by the second node. In a second step the method 1000 comprises sending 1004 a first message to a first node, to cause the first node to send a second message to the UE indicating a power control configuration parameter with which the UE should send the further transmissions, wherein the power control configuration parameter is determined based on the estimated received power.

In more detail, as noted above, the second node may be configured to receive uplink transmissions from the UE, but not configured to transmit in the downlink to the UE. As such, the second node may act as an intermediary node and forward transmissions from the UE to the first node.

In some embodiments, in the RRC configuration of the UE α_{b,f,c}(j) is set to 0 in order to turn off the (prior art) open loop UL PC. This may thus be used to signify that the UE is to perform PC with respect to the second node in the manner described herein.

The power control configuration parameters are determined based on an estimated received power of an initial transmission sent from the UE and received by the second node.

The initial transmission may be a reference signal. The initial transmission may, for example, be an SRS transmission (but also other kinds of signals like e.g. DMRS, PUSCH, PUCCH and PRACH are applicable). The initial transmission is sent by the UE and received by the second node.

In some embodiments, the initial transmission from the UE to the first node comprises a power headroom report, PHR. It is then received by the first (UL only) radio node and may then be communicated to the second radio node. Information related to PHR may then be used to decide on UL power control related parameters that the second radio node will transmit to the UE (e.g. in step 704).

The initial transmission may be performed using an initial set of power control parameters, e.g. sent with an initial power level, and where different beams are configured, using an initial power control loop corresponding to an initial beam.

In some embodiments, the initial transmission may be initiated by the first node. For example, preceding the steps 702, 704, 1002 and 1004, the first node may send a configuration message to the UE to cause the UE send the initial transmission.

In other embodiments, the initial transmission may be initiated by the second node. For example, the second node may send a message to the first node to instruct the first node to send the configuration message to the UE to cause the UE to send the initial transmission.

In other embodiments, the UE may initiate the process by sending the initial transmission itself (e.g. without being prompted by the first or second nodes).

The initial transmission may be received, or is receivable by, the second node. The UE may send the initial transmission to the second node. More generally the UE may make a transmission to whichever nodes are listening and the second node may receive this.

The second node receives the initial transmission and determines (e.g. estimates) the estimated received power of the initial transmission. This is shown in step 1002 of the method 1000 in FIG. 10.

In some embodiments, the second node sends the estimated received power of the initial transmission to the first node for the first node to determine the power control configuration parameter. The second node may send the estimated received power of the initial transmission to the first node in a first message. The first message may trigger or cause the first node to send the second message to the UE indicating a power control configuration parameter with which the UE should send the further transmissions to the second node.

From the point of view of the first node, the step of obtaining 702 the power control configuration parameter may thus comprise receiving a first message from the second node, comprising an indication of the estimated received power of the initial transmission (as measured at the second node), and determining the power control configuration parameter, based on the estimated received power of the initial transmission as indicated in the first message. In other words, the second (e.g. UL only) node may estimate the received power of the initial transmission and send the estimated received power (or information related to estimated power) to the first node for the first node to determine the power control configuration parameter with which the UE should send further transmissions to the second node.

In other embodiments, the second node may estimate the received power of the initial transmission and then determine the power control configuration parameter with which the UE should send further transmissions to the second node. The second node may thus send the determined power control configuration parameter(s) to the first node for the first node (e.g. for the first node to effectively forward on). Thus, from the point of view of the first node, in some embodiments, in step 702 the power control configuration parameter may be received from the second node in the first message.

The first message may be sent from the second node to the first node e.g. via a backhaul or a similar communication channel.

The skilled person will appreciate that these are examples and that the appropriate power control configuration parameter may be translated or determined from the estimated received power of the initial transmission at either the first or second node. The processing may alternatively be split between the first and second nodes in any manner.

The power control configuration parameter indicates (e.g. provides information from which the UE can determine) a power with which the UE should send the further transmissions that are to be received by the second node. The power control configuration parameters may relate, for example, to PUSCH UL PC, PUCCH UL and/or SRS PC.

The power control configuration parameter may indicate an absolute power with which the further transmissions should be made. Alternatively, the power control configuration parameter may indicate an adjustment that should be made to the power with which the initial transmission was made.

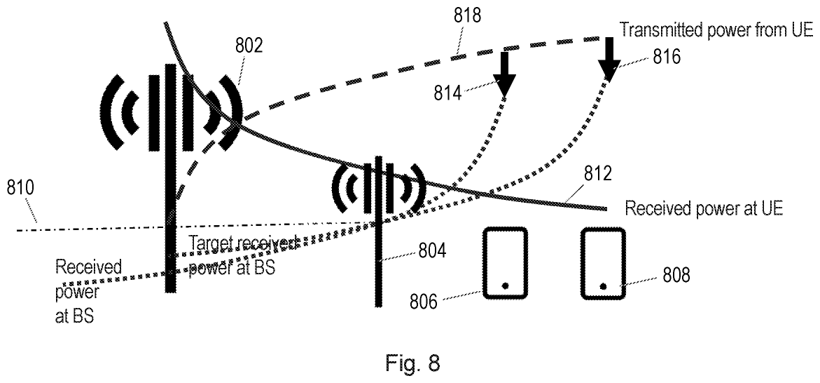

In some embodiments, the power control configuration parameter can indicate an adjustment to the power with which the UE should send the further transmissions, compared to a power used by the UE to send the initial transmission, in order for the further transmissions to be received at the second node at a target received power level. This is illustrated in FIG. 8 which shows adjustments 814 and 816 that should be made to the power level (indicated by the dashed line 818) of transmission made by two UEs 806 and 808 at different distances from a second, UL only, node 804 in order for the transmissions to reach the UL only node 804 at the target received power (as indicated by the horizontal dash-dot line 810).

This has the technical effect that the UEs 806, 808 are able to save power and, by not using more power than is necessary, interference is reduced which is beneficial to other UEs operating in the communications network. By leveraging the UL only node 804 in this way, the network is more efficient.

Put another way, in some embodiments, the step of obtaining 702 a power control configuration parameter comprises the first node: determining a first adjustment (or increment) by which the UE should change the transmission power compared to a power used by the UE to send the initial transmission. In such embodiments, the power control configuration parameter in the second message may indicate the determined first adjustment.

Adjustments may be made, e.g. via a TPC command. For example, by changing the value of δ_{PUSCH,b,f,c}(i,l) (the TPC (Transmission Power Control) command value), as described above).

In another embodiment, beam specific PC is used to configure multiple different UL PC loops with different power levels. As an example, consider the case that

P_{O_PUSCH,b,f,c}(1)=X [dB] and

P_{O_PUSCH,b,f,c}(2)=X+10 [dB]

This will hence mean that there will be a 10 dB difference between the first and second power control loop. These two loops may then be used to adjust the UE's power; if it is concluded that a larger change in UL transmission power is desired, the first radio 402 can instruct the UE 406 to switch from one power control loop to another.

In other words, the step of obtaining 702 a power control configuration parameter may comprise the first node: determining a first adjustment by which the UE should change the transmission power compared to a power used by the UE to send the initial transmission, and if the first adjustment is larger than a predefined threshold, determining that the UE should change to another set of power control parameters corresponding to another power control loop (e.g. another beam with a different power level), in order to change the transmission power for the future transmissions. The power control configuration parameter(s) in the second message may then indicate the other set of power control parameters.

The predefined threshold, may for example, correspond to the difference in power between the different beams corresponding to the different values of j.

The other set of power control parameters may indicate, for example, a value of the index j to be used in the term P_{O_PUSCH,b,f,c}(j), as described above whereby different beams are represented by different values of j. The j value may be sent in the second message which may be a DCI message or via MAC CE.

A combination of smaller adjustments (e.g. via TPC) and larger adjustments (via a change in power control loop via the parameter j) may also be considered. For example, step 702 may further comprise the first node determining a second adjustment by which the UE should change the transmission power compared to the power level of the other power control loop. The power control parameter in the second message may thus further indicate the second adjustment.

As an example, one could consider other parameter settings as e.g.
P_{O_PUSCH,b,f,c}(3)=X−10 [dB] to enable additional large changes in UL transmission power and/or
P_{O_PUSCH,b,f,c}(4)=X+1 [dB] to enable more fine tuning of the transmission power.
   In some examples, the indexes q_{d} and/or l may be used to switch between different power control loops. In another embodiment some of the parameters are also reconfigured, e.g. a new value for P_{O_PUSCH,b,f,c}(i) may be configured from the second radio node to the UE.

Turning to step 704, once the power control configuration parameter is determined, the first node 402 then sends a second message to the UE 406, 600 indicating the obtained power control configuration parameter.

For example, an adjustment such as that shown in FIG. 8 may be sent to the UE in a TPC command (to appropriately adjust the UE UL transmission power). This TPC may then be transmitted from the first node to the UE in a second message in the form of a DL transmission in e.g. a DCI message.

In this way, power control may be performed to ensure further (e.g. future) transmissions from the UE to the second node are appropriately configured and are at an appropriate power level (e.g. such that they are received by the second node at the target received power level), without the second node needing to transmit in the DL to the UE.

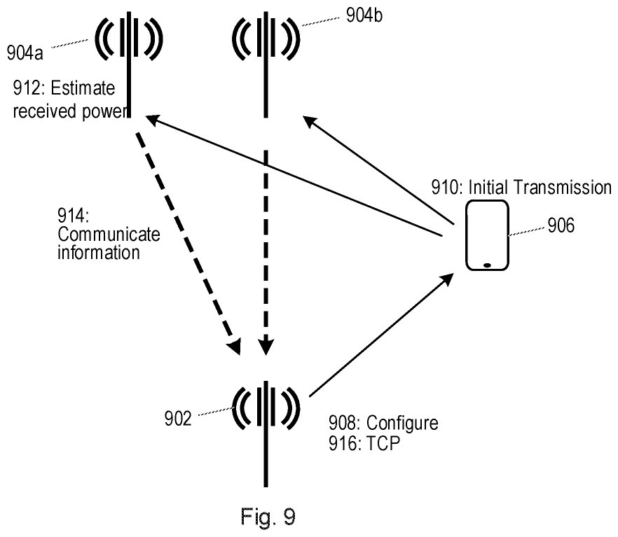

Turning now to other embodiments, in some embodiments, the methods described herein may be extended to third and/or subsequent (UL only) radio nodes, which all receive the initial transmission from the UE. This would then result in multiple estimates of the received power which are communicated to the first radio node. This is illustrated in FIG. 9 whereby there are two UL only nodes 904a and 904b which receive an initial transmission 910 from a UE 906. Both UL only nodes 904a and 904b estimate 912 the received power of the initial transmission 910 and each sends a “first” message 914 to the first node 902, to cause the first node to send a second message to the UE indicating a power control configuration parameter with which the UE should send the further transmissions. In this embodiment, the power control configuration parameter is determined based on the estimated received power at both nodes 904a and 904b.

In other words, both the second node 904a and the third node 904b perform the method 1000 on an initial transmission from the UE.

From the point of view of the first node 902, in this embodiment, the method 700 may further comprise: receiving a third message from a third node, comprising an estimated received power of the initial transmission sent from the UE, as measured at the third node. The step of obtaining a power control configuration parameter is then further based on the estimated received power at the third node.

As an example, the UE 406, 600 may be instructed to adjust its power such that the power level is received at both the second and third nodes is above a target received power level. As another example the UE may be instructed to adjust its power so that if signals received by the second node 904a and third node 904b from the UE are combined, the combined power is above a threshold power level such as the target receive power.

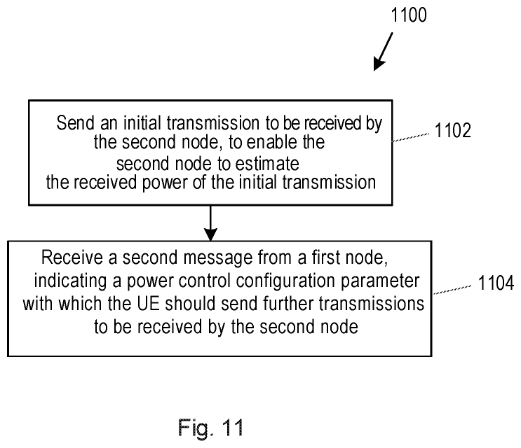

Turning now to the UE, FIG. 11 shows a method 1100 performed by a UE for setting a power control parameter with which the UE should send further transmissions to be received by a second node in the communications network. Briefly, in a first step the method comprises sending 1102 an initial transmission to be received by the second node, to enable the second node to estimate the received power of the initial transmission. In a second step the method 1100 then comprises receiving 1104 a second message from a first node, indicating a determined power control configuration parameter with which the UE should send further transmissions to be received by the second node, based on the estimated received power of the initial transmission.

The initial transmission and the second message were described in detail above with respect to the methods 700 and 1000 and the detail therein will be understood to apply equally to the method 1100.

As noted above, in the RRC configuration of the UE, α_{b,f,c}(j)=0 may be configured to turn off the open loop UL PC.

The method 1100 allows the UE to perform power control processes for transmissions to a second node, even if the second node is unable to perform ordinary power control processes. This enables, for example, the UE to perform power control with respect to transmissions to an UL only node, where traditional open and closed loop PC are not possible.

Turning now to other embodiments, some of the embodiments herein may be summarised in the following steps:
1. Configure an UL transmission from a UE to the second (UL only) radio node,
2. Perform the configured transmission
3. Estimate the received power, at the second radio node, of the said UL transmission
4. Communicate information related to the estimated received power to a first radio node
5. From the first radio node, transmit information related to UL PC to the said UE
As noted above, the first UL radio node and the second radio nodes may be located at different geographical locations.
The second radio node may be an UL only node
For steps 1-2 the UL transmission may be SRS, DMRS, PUCCH, PUSCH or PRACH.
For step 5 the UL PC information may be
1. Related to PUSCH, PUCCH or SRS UL PC and/or
2. A TPC command and/or
3. An index referring to one out of multiple UL PC loops
Furthermore steps 4-5 may include a PHR obtained from the UE in step 2.
Furthermore, the examples may be extended to a set of multiple UL-only nodes.
   In this way there is provided UL power control for decoupled DL and UL transmission.

In other embodiments there is a computer program comprising instructions which, when executed on at least one processor, cause the at least one processor to carry out any of the methods described herein such as the methods 700, 1000 and 1100.

In some embodiments there is a carrier containing such a computer program, wherein the carrier comprises one of an electronic signal, optical signal, radio signal or computer readable storage medium. In some embodiments there is also a computer program product comprising non transitory computer readable media having stored thereon such a computer program.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

### ANNEX 1

Mapping of TPC Command Field in DCI format 0_0, DCI format 0_1, or DCI format 2_2.

| TPC Command | Accumulated δ_{PUSCH, b, f, c} | Absolute δ_{PUSCH, b, f, c} |
|---|---|---|
| Field | or δ_{SRS, b, f, c} [dB] | or δ_{SRS, b, f, c} [dB] |
| 0 | −1 | −4 |
| 1 | 0 | −1 |
| 2 | 1 | 1 |
| 3 | 3 | 4 |

1. A computer implemented method performed by a first node in a communications network for setting a power control configuration parameter with which a user equipment, UE, should send further transmissions to a second node in the communications network, the method comprising:
obtaining the power control configuration parameter with which the UE should send the further transmissions to be received by the second node, the power control configuration parameter being based on an estimated received power of an initial transmission sent from the UE and received by the second node, as measured at the second node; and
sending a second message to the UE indicating the obtained power control configuration parameter.

2. A method as in claim 1 wherein the second node is configured to receive uplink transmissions from the UE, but is not configured to transmit in the downlink to the UE.

3. A method as in claim 2 wherein the second node acts as an intermediary node and forwards transmissions from the UE to the first node.

4. A method as in claim 1 further comprising:
receiving a first message from the second node, comprising an indication of the estimated received power of the initial transmission sent from the UE and received by the second node, as measured at the second node; and wherein the step of obtaining the power control configuration parameter comprises:
determining the power control configuration parameter, based on the estimated received power of the initial transmission as indicated in the first message.

5. A method as in claim 1 wherein the obtaining a power control configuration parameter comprises:
receiving the power control configuration parameter from the second node.

6. A method as in claim 1 wherein the power control configuration parameter indicates a power with which the UE should send the further transmissions that are to be received by the second node.

7. A method as in claim 1 wherein the power control configuration parameter indicates an adjustment to the power with which the UE should send the further transmissions, compared to a power used by the UE to send the initial transmission, in order for the further transmissions to be received at the second node at a target received power level.

8. A method as in claim 1 wherein the obtaining a power control configuration parameter comprises:
determining a first adjustment by which the UE should change the transmission power compared to a power used by the UE to send the initial transmission; and
wherein the power control configuration parameter in the second message indicates the determined first adjustment.

9. A method as in claim 1 wherein the obtaining a power control configuration parameter comprises:
determining a first adjustment by which the UE should change the transmission power compared to a power used by the UE to send the initial transmission; and
if the first adjustment is larger than a predefined threshold, determining that the UE should change to another set of power control parameters corresponding to another power control loop, in order to change the transmission power for the future transmissions;
wherein the power control configuration parameter in the second message indicates the other set of power control parameters.

10. A method as in claim 9 further comprising:
determining a second adjustment by which the UE should change the transmission power compared to the power level of the other power control loop, and
wherein the power control parameter in the second message further indicates the second adjustment.

11. A method as in claim 1 further comprising:
receiving a third message from a third node, comprising an estimated received power of the initial transmission sent from the UE, as measured at the third node; and
wherein the step of obtaining a power control configuration parameter is further based on the estimated received power at the third node.

12. A method as in claim 1 wherein, preceding the obtaining the power control configuration parameter, the method further comprises sending a configuration message to the UE to cause the UE to send the initial transmission.

13. A method as in claim 1 wherein the second message comprises a Transmit Power Control, TPC, command.

14. A method as in claim 1 wherein the initial transmission from the UE to the first node comprises a power headroom report, PHR.

15. A computer implemented method performed by a second node in a communications network for setting a power control configuration parameter with which a user equipment, UE, should send further transmissions that are to be received by the second node, the method comprising:
determining an estimated received power of an initial transmission sent by the UE and received by the second node; and
sending a first message to a first node, to cause the first node to send a second message to the UE indicating a power control configuration parameter with which the UE should send the further transmissions, wherein the power control configuration parameter is determined based on the estimated received power.

16. A method as in claim 15 wherein the second node is configured to receive uplink transmissions from the UE, but is not configured to transmit in the downlink to the UE.

17. A method as in claim 15 further comprising the second node:
determining the power control configuration parameter with which the UE should send the further transmissions that are to be received by the second node, based on the estimated received power; and
sending the determined power control configuration parameter in the first message.

18. A method as in claim 15 further comprising:
sending the estimated received power in the first message, for use by the first node in determining the power control configuration parameter with which the UE should send the further transmissions that are to be received by the second node, based on the estimated received power.

19. A computer implemented method performed by a user equipment, UE, in a communications network for setting a power control configuration parameter with which the UE should send further transmissions to be received by a second node in the communications network, the method comprising:
sending an initial transmission to be received by the second node, to enable the second node to estimate the received power of the initial transmission; and
receiving a second message from a first node, indicating a determined power control configuration parameter with which the UE should send further transmissions to be received by the second node, based on the estimated received power of the initial transmission.

20. A method as in claim 19 wherein the second node is configured to receive uplink transmissions from the UE, but is not configured to transmit in the downlink to the UE.

21. A method as in claim 19 wherein the UE is configured to turn off open loop uplink power control.

22. A first node in a communications network for setting a power control configuration parameter with which a user equipment, UE, should send further transmissions to a second node in the communications network, the first node comprising: a memory comprising instruction data representing a set of instructions; and
a processor configured to communicate with the memory and to execute the set of instructions, wherein the set of instructions, when executed by the processor, cause the processor to:
obtain the power control configuration parameter with which the UE should send the further transmissions to be received by the second node, the power control configuration parameter being based on an estimated received power of an initial transmission sent from the UE and received by the second node, as measured at the second node; and
send a second message to the UE indicating the obtained power control configuration parameter.

23.-33. (canceled)
